(19) United States
(12) Patent Application Publication
(10) Pub. No.: US 2002/0105693 A1
(43) Pub. Date: Aug. 8, 2002

(54) Optical transmission unit and system

(75) Inventors: Masato Kobayashi, Kanagawa (JP); Hideaki Koyano, Kanagawa (JP); Kazumaro Takaiwa, Kanagawa (JP); Akio Takayasu, Kawasaki (JP); Maki Hiraizumi, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/115,247

(22) Filed: Apr. 4, 2002

Related U.S. Application Data
(63) Continuation of application No. PCT/JP99/06270, filed on Nov. 10, 1999.

(51) Int. Cl. H04B 10/08; H04J 14/02

(52) U.S. Cl. 359/124; 359/110

(57) ABSTRACT

An optical transmission unit and optical transmission system which have more efficient failure recovery functions to provide improved communication services, without increasing the size of network equipment. A control channel manager manages a control channel, as well as a control channel signal on that channel, for the purpose of failure recovery of optical signal transport. An optical switch fabric switches optical signal paths to perform protection switching between working facilities and protection facilities. A protection switching controller sends a switching command to the optical switch fabric, based on the information provided through the control channel.

### BACKGROUND OF THE INVENTION

1. Field of the Invention

The present invention relates to an optical transmission unit and an optical transmission system. More particularly, the present invention relates to an optical transmission unit which transports optical signals with wavelength-division multiplexing techniques, and to an optical transmission system which performs the same on a ring network.

2. Description of the Related Art

Recent years have seen a remarkable progress in development of fiber optic networks, a key technology for our data communication infrastructures. To meet the ever-growing demands for more sophisticated and diversified services toward the information-age society, various new optical communications technologies have emerged. As one of the achievements, wavelength division multiplexing (WDM) techniques are widely used in today's latest optical communications systems. The WDM technology enables many transmission signals to be carried over a single fiber optic medium, assigning different optical wavelengths to different communication channels. Researchers have also studied various network topologies suitable for different implementation areas of optical communication.

FIG. 13 shows a simple example of an optical ring network, in which network nodes 100-1 to 100-4 are connected in a ring topology with fiber optical cables. The illustrated system are configured with a dual redundant architecture to provide higher reliability and availability. When a problem occurs with a working channel, the system will immediately switch the traffic signals from the failed channel to a protection channel, thereby preventing the communication from being disrupted. Such a ring topology is suitable for relatively large networks because there is basically no limitation on the number of connectable nodes, and many optical ring networks are actually deployed as trunk facilities for private local networks.

FIG. 14 schematically shows the internal structure of a conventional network node. The illustrated node 100-1 has working and protection facilities to link with neighboring nodes. It contains demultiplexers 101a to 101d, optical-to-electrical (O/E) converters 102a to 102d, electrical-to-optical (E/O) converters 103a to 103d, multiplexers 104a to 104d, and electrical switch controllers 111 and 112. The demultiplexers 101a to 101d split an incoming WDM signal containing multiple signals with different wavelengths λ1 to λn into individual signals. The O/E converters 102a to 102d receive such optical signals from the demultiplexers 101a to 101d and convert them into electrical signals.

The electrical switch controllers 111 and 112 contain a plurality of electrical switches to reconfigure the paths of electrical signals produced by the O/E converters 102a to 102d. When a failure occurs, they switch working channels to protection channels to recover the system from that failure. FIG. 14 shows that the node 100-1 is configured to make signals propagate through working channels.

The E/O converters 103a to 103d convert the electrical output signals of the electrical switch controllers 111 and 112 back to optical signals with different wavelengths. Each of the multiplexers 104a to 104d combines those optical signals for transmission over a single fiber optic medium, the resultant WDM signal containing multiple wavelength components λ1 to λn.

As seen from the above, the conventional ring network terminates optically-multiplexed signals at each node to switch the signal paths electrically, meaning that every node must have signal converters and switches for each individual wavelength. The problem here is that the size and complexity of network node equipment would increase with the number of WDM channels. To overcome this difficulty, some network nodes are equipped with optical switches, instead of electrical switches, so that path switching can be performed all optically. Such nodes, however, have a problem in identifying the location of a link failure when communication is disrupted. Details are provided below.

FIG. 15 shows a situation where a link failure has occurred in a conventional ring network. This network includes four nodes 200-1 to 200-4 with all-optical switching facilities to route incoming optical signals to the next node without regeneration. Each node monitors the status of main optical signals and invokes protection switching if any error is detected.

It is supposed that a failure occurred somewhere on the link between the first and second nodes 200-1 and 200-2 as shown in FIG. 15. This single link failure is detected as an incoming signal loss error at the first node 200-1, but the other three nodes 200-2 to 200-4 also observe the same error simultaneously because of the nature of all-optical systems. That is, the detection of main optical signal status is not sufficient for the nodes to locate a link failure in this type of network.

Further, in conventional optically-switched ring network systems, there is no optical signal on an unused transmission medium (e.g., those reserved for protection purposes) in normal situations; it is, in other words, a mere dark fiber. Such systems have a potential risk of unsuccessful protection switching because they are unable to ensure the integrity of protection facilities before switching.

### SUMMARY OF THE INVENTION

In view of the foregoing, it is an object of the present invention to provide an optical transmission unit which has more efficient failure recovery functions to offer improved communication services, without increasing the size of equipment.

It is another object of the present invention to provide an optical transmission system which has more efficient failure recovery functions to offer improved communication services, without increasing the size of equipment.

To accomplish the first object stated above, the present invention provides an optical transmission unit which transports optical signals with wavelength-division multiplexing techniques. This optical transmission unit comprises the following element: a control channel manager which manages a control channel and a control channel signal thereon for use in failure recovery operations; an optical switch fabric which switches optical connection paths between working facilities and protection facilities to route the optical signals; and a protection switching controller which sends a switching command to the optical switching unit, based on the control channel signal.

Further, to accomplish the second object stated above, the present invention provides an optical transmission system which transports optical signals over a ring network with wavelength-division multiplexing techniques. This optical transmission system comprises a plurality of optical transmission units and optical transmission media to interconnect them in a ring topology. Each optical transmission unit comprises the following element: a control channel manager which manages a control channel and a control channel signal thereon for use in failure recovery operations; an optical switch fabric which switches optical connection paths between working facilities and protection facilities to route the optical signals; and a protection switching controller which sends a switching command to the optical switching unit, based on the control channel signal.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of an optical transmission unit according to the present invention;

FIGS. 2 and 3 show a block diagram of an optical switch fabric and its surroundings;

FIG. 4 shows a frame format of control channel signals;

FIG. 5 shows how the proposed system locates a defective point when a link failure has occurred;

FIG. 6 is a diagram which explains a dummy light transmitter;

FIG. 7 is a diagram which explains an optical wavelength converter;

FIG. 8 shows a ring network including optical transmission units;

FIG. 9 shows a situation where a failure has occurred in the ring network of FIG. 8;

FIG. 10 shows protection switching performed to solve the problem of FIG. 9;

FIG. 11 shows another problem situation of the ring network;

FIG. 12 shows protection switching performed to solve the problem of FIG. 11;

FIG. 13 shows an optical ring network;

FIG. 14 schematically shows the internal structure of a conventional network node; and

FIG. 15 shows a situation where a link failure has occurred in a conventional ring network.

### DESCRIPTION OF THE PREFERRED EMBODIMENTS

Preferred embodiments of the present invention will be described below with reference to the accompanying drawings.

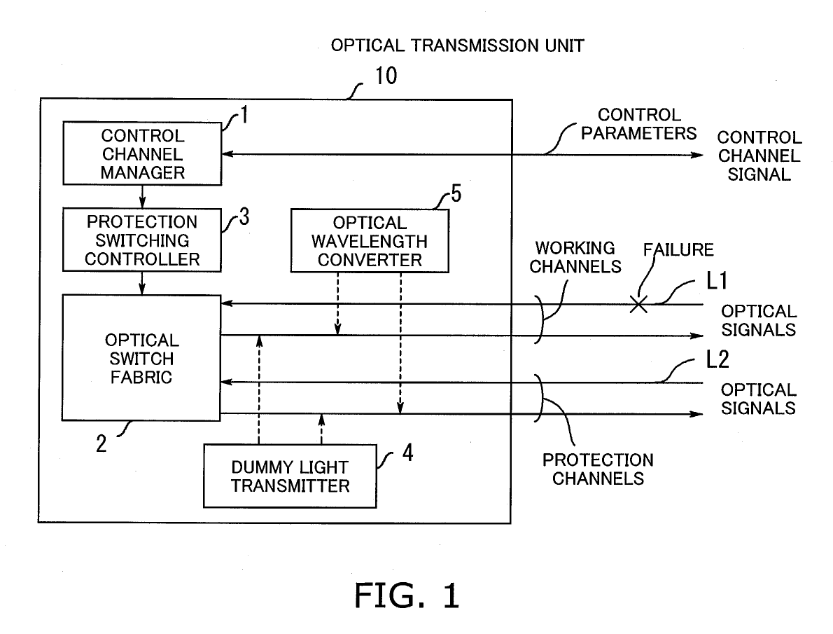

FIG. 1 is a conceptual view of an optical transmission unit according to the present invention. The illustrated optical transmission unit 10 serves as a node in a ring network which transports optical signals with wavelength-division multiplexing (WDM) techniques. The present invention is directed not only to this optical transmission unit 10 itself, but also to an optical transmission system where a plurality of such optical transmission units are interconnected by optical transmission media (e.g., fiber optic cables), forming a ring network.

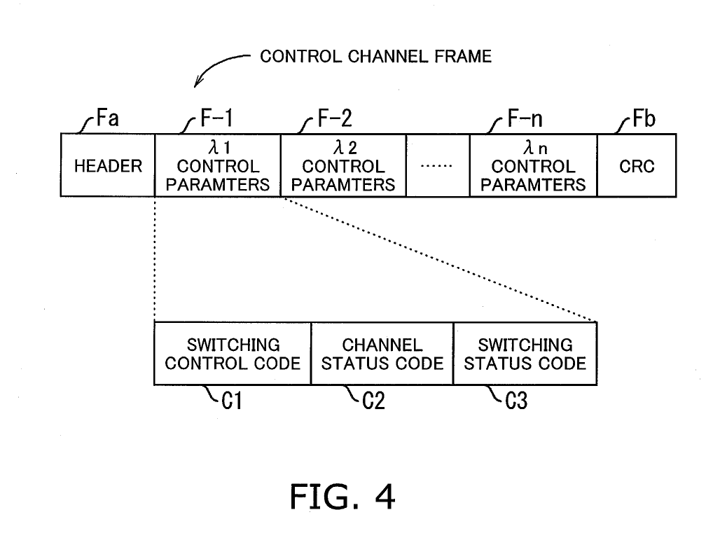

The proposed optical transmission unit 10 has the following functional blocks: a control channel manager 1, an optical switch fabric 2, a protection switching controller 3, a dummy light transmitter 4, and an optical wavelength converter 5. The control channel manager 1 manages a control channel, as well as a control channel signal carried on that channel, for the purpose of failure recovery of optical signal transport. Typically, this control channel signal is multiplexed with main optical signals, whose detailed frame format will be described in detail later with reference to FIG. 4.

Data traffic channels, as opposed to the control channel, convey information-carrying optical signals, which are referred to herein as the “main signals.” Each main signal is assigned a unique wavelength selected from among the available wavelength resources λ1 to λn. One unused wavelength out of λ1 to λn may be allocated to the control channel, meaning that the control channel resides within the band of an optical repeater amplifier (not shown in FIG. 1) integrated in the optical transmission unit 10.

Alternatively, the control channel is set up with a dedicated wavelength channel (e.g., λ0), aside from the main signal wavelengths λ1 to λn. In this case, the control channel resides outside the repeater amplifier's bandwidth, without sacrificing any of the main-signal wavelength resources.

An optical signal received from one neighboring unit through the control channel is converted to an electrical signal in the optical transmission unit 10 for termination, and then regenerated as an optical signal again for delivery to the next unit.

The optical switch fabric 2 changes optical signal paths to perform protection switching between working channels and protection channels. The protection switching controller 3 sends a switching command to this optical switch fabric 2, based on the information provided through the control channel. When, for example, a failure occurs somewhere on a working channel L1, the protection switching controller 3 commands the optical switch fabric 2 to route the main signal to a protection channel L2. This protection switching may be applied only to that particular channel that is failed (unidirectional protection switching), or to the channels in both directions at the same time (bidirectional protection switching).

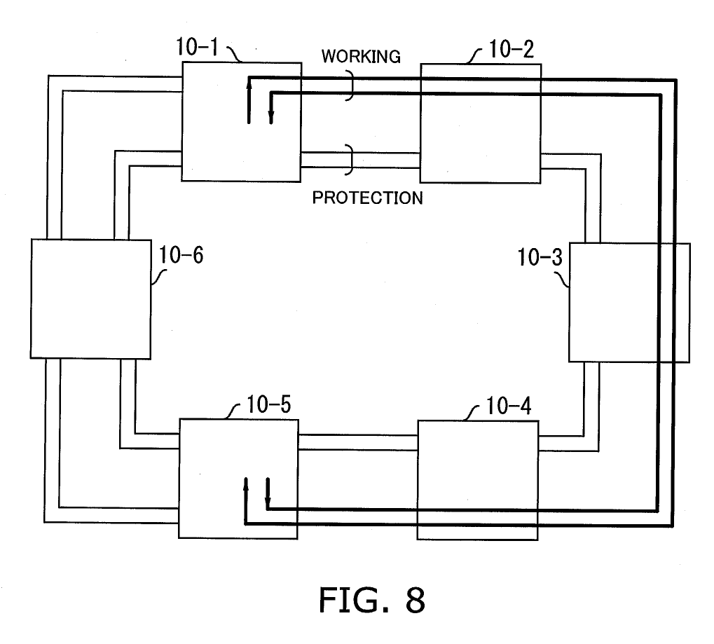

When optical signals propagating in the east direction, for example, are disrupted because of some failure, and if that failure affects both working and protection channels, the protection switching controller 3 commands the optical switch fabric 2 to route the signals to the westbound route, as will be described in detail later with reference to FIGS. 8 to 12.

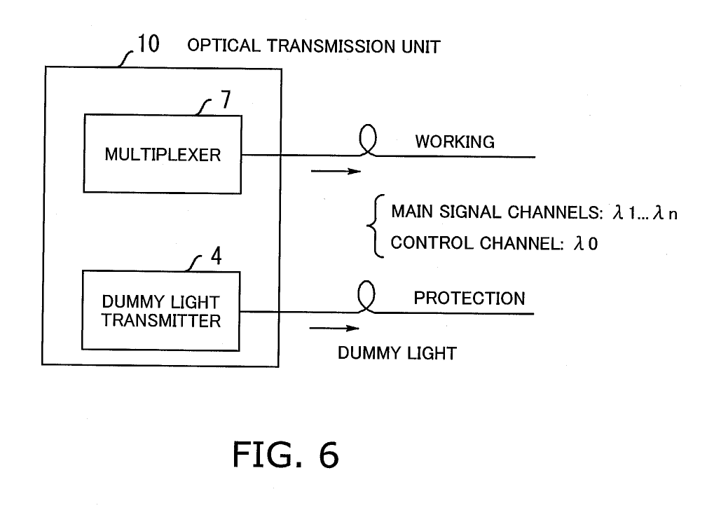

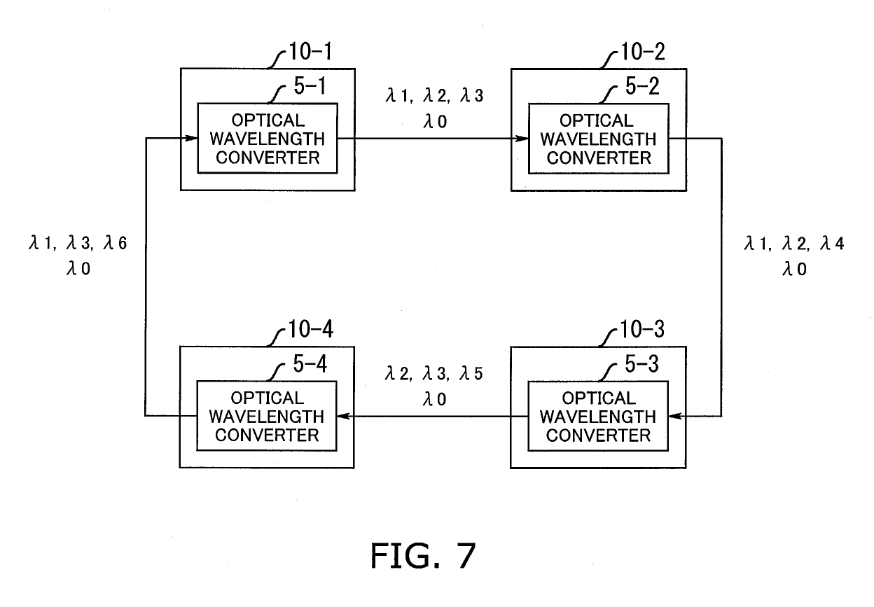

The dummy light transmitter 4 sends a dummy light into outgoing working facilities or outgoing protection facilities, whichever not used to carry the main signals. More specifically, it supplies a dummy light to protection channels when working channels are operating. The optical wavelength converter 5 converts the wavelength of an optical signal to any other wavelength, allowing each node on the ring network to retransmit received optical signals with different wavelengths. The details of these dummy light transmitter 4 and optical wavelength converter 5 will be discussed later in FIGS. 6 and 7.

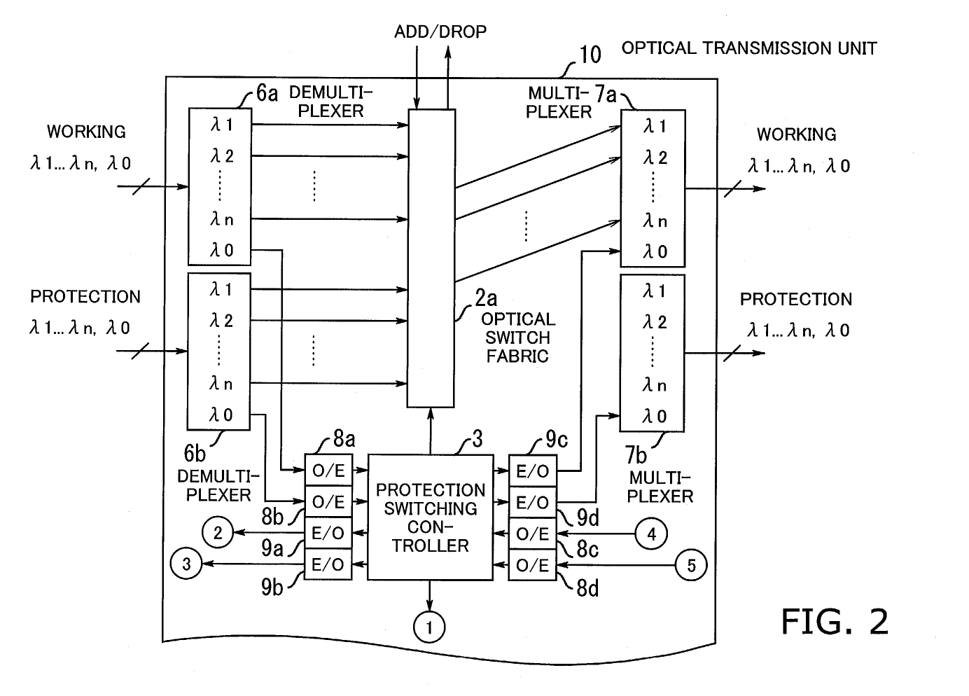

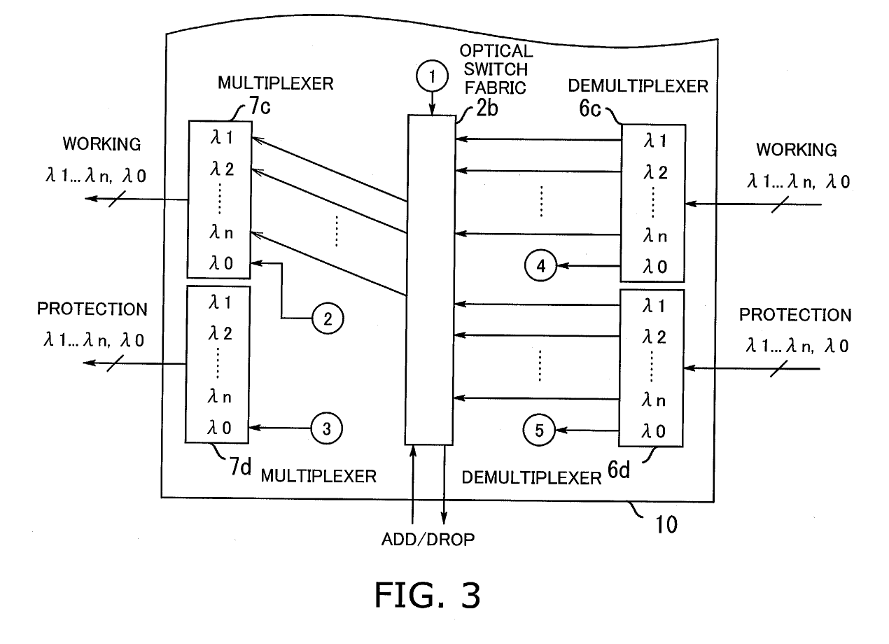

FIGS. 2 and 3 show a block diagram of the optical switch fabric 2 and its surroundings. Referring now to these FIGS. 2 and 3, the next section will focus on how the control channel is used to perform protection switching of optical signals.

The illustrated optical transmission unit 10 performs WDM transmission, assigning the wavelengths λ1 to λn to main signal channels and λ0 to the control channel. To this end, the optical transmission unit 10 has the following elements: optical switch fabrics 2a and 2b, a protection switching controller 3, demultiplexers 6a to 6d, multiplexers 7a to 7d, O/E converters 8a to 8d, and E/O converters 9a to 9d.

Incoming WDM signals contain different optical wavelength components λ0 to λn. The demultiplexer 6a to 6d demultiplex them into individual signals. The demultiplexed control channel signals λ0 are routed from the demultiplexers 6a to 6d to the O/E converters 8a to 8d, respectively, for optical-to-electrical conversion.

The protection switching controller 3 sends switching commands to the optical switch fabrics 2a and 2b, according to the control channel information. The optical switch fabrics 2a and 2b change the path of main signals according to the command sent from the protection switching controller 3, thus performing protection switching to recover the system from failure. FIGS. 2 and 3 show that the optical transmission unit 10 is currently configured to make signals propagate through working channels. The optical switch fabrics 2a and 2b also support add/drop functions to insert and extract tributary signals with particular wavelengths to/from the main signals being switched.

The E/O converters 9a to 9d each convert the electrical control channel signal back to an optical signal with the wavelength λ0. The multiplexers 7a to 7d combine outgoing optical signals λ1 to λn supplied from the optical switch fabrics 2a and 2b, together with the optical control channel signals λ0 provided from E/O converters 9a to 9d, thereby producing outgoing WDM signals.

Referring to FIG. 4, the frame format of control channel signals is shown. A control channel frame consists of a frame header field Fa, control parameter fields F-1 to F-n for individual wavelengths λ1 to λn, and a cyclic redundancy check (CRC) code field Fb for error detection. Each control parameter field F-1 to F-n consists of a switching control code subfield C1, a channel status code subfield C2, and a switching status code subfield C3.

The switching control code subfield C1 contains information about whether the channel has been protection-switched or not. The channel status code subfield C2 indicates whether the working and protection channels are operating properly. The switching status code subfield C3 contains information about which facilities (i.e., working or protection) is currently activated for the channel.

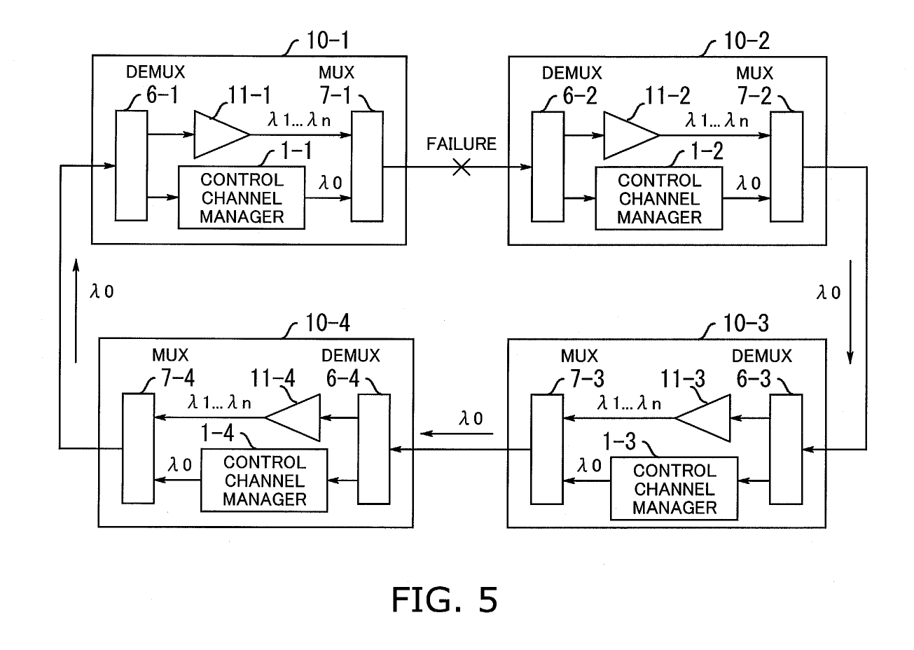

When a link failure occurs in the proposed optical transmission system, the optical transmission units 10 on the network attempt to locate the faulty point. Referring next to FIG. 5, the failure locating process of the proposed system will be described below.

FIG. 5 shows a ring network of four nodes 10-1 to 10-4 linked by fiber optic cables. Each node 10-n (n=1 . . . 4) has a control channel manager 1-n which manages the control channel (wavelength λ0), a demultiplexer (DEMUX) 6-n, a multiplexer (MUX) 7-n, and an optical amplifier 11-n which amplifies main signals λ1 to λn.

It is supposed here that a link failure has occurred at a point between the first node 10-1 and second node 10-2 as shown in FIG. 5. In such a problem situation, the conventional system would not be able to identify the location of the failure. This is because the disruption of a main optical signal would propagate all over the network, making every node 10-1 to 10-4 detect the same failure simultaneously.

Unlike the conventional system, the proposed optical transmission system can locate the problem by sending control channel information from node to node for failure recovery purposes. In the example of FIG. 5, the link failure is recognized by the control channel manager 1-2 in the second node 10-2 as an optical signal loss of its incoming control channel. The control channel manager 1-2 then produces a control channel signal λ0 containing information about the detected failure. The produced control channel signal λ0 is sent to the next node 10-3 through the multiplexer 7-2, which is then passed to the third node 10-3 and fourth node 10-4. The signal λ0 finally reaches the first node 10-1 and it is terminated at that node.

In the way described above, the proposed optical transmission system employs a control channel, besides the main signal channels, to carry an extra optical signal for monitoring purposes. Unlike the main signal channels, the control channel is terminated at each node and regenerated for delivery to the next node. It is therefore possible for the system to quickly locate a link failure.

While the above system assigns a dedicated wavelength λ0 to the control channel, the invention should not be limited to that configuration. It is also possible to share the main optical channels to convey the intended control information by modulating main signals with the control channel signal.

Referring now to FIG. 6, the dummy light transmitter 4 will be explained below. As described earlier, the multiplexer 7 combines a plurality of main signals λ1 to λn and a control channel signal λ0 into a single optical transmission medium. The dummy light transmitter 4 sends a dummy light into either a protection channel or a working channel, whichever is not activated to carry a main signal. When, for example, the working facilities are used to transport the main signals λ1 to λn and control channel signal λ0, the dummy light transmitter 4 injects a dummy light to the protection facilities. When the protection facilities are activated in turn to transport those signals, the dummy light transmitter 4 injects a dummy light to the working facilities. This is unlike the conventional system, in which the unused protection facilities are merely a dark fiber. The dummy light in the present invention may be supplied as a fraction of main signals or control channel signal λ0. Another possible implementation is to employ a dedicated light source for the dummy light.

As seen from the above description, the present invention provides a dummy light transmitter 4 to send a dummy light into backup fibers which are not used for the present communication in preparation for future protection switching. This feature of the present invention facilitates the optical transmission units to ensure the integrity of protection channels when protection switching is necessitated by a link failure.

Referring next to FIG. 7, the optical wavelength converter 5 will be explained below. FIG. 7 shows a ring network with four nodes 10-1 to 10-4 according to the present invention. Each node 10-1 to 10-4 has an optical wavelength converter 5-1 to 5-4 to convert the wavelengths of optical signals in an intended way. More specifically, the first optical wavelength converter 5-1 outputs main signals with wavelengths λ1, λ2, and λ3. The second node 10-2 receives them and outputs λ1, λ2, and λ4, after converting λ3 to λ4 with its integral optical wavelength converter 5-2. Similarly, the third optical wavelength converter 5-3 outputs λ2, λ3, and λ5, and the fourth optical wavelength converter 5-4 outputs λ1, λ3, and λ6. Unlike those main signals, the control channel signal λ0 propagates from node to node, without being converted to other wavelengths.

As seen from the above description, the proposed system has an optical wavelength converter 5 at each node to allow an incoming optical signal to be retransmitted with a different wavelength, as required. Since this feature permits a different wavelength channel to be used to transport a main signal, the system can continue communication even if a particular wavelength channel goes down.

Referring to FIGS. 8 to 12, the protection switching operation of the proposed optical transmission system will be described below. FIG. 8 shows a ring network in which six optical transmission units 10-1 to 10-6 are interconnected by fiber optical cables. This transmission system is configured as a four-fiber redundant ring network with a protection switching capability. It is assumed here that the first optical transmission unit 10-1 is communicating with the fifth optical transmission unit 10-5 through working channels as indicated by the bold lines in FIG. 8.

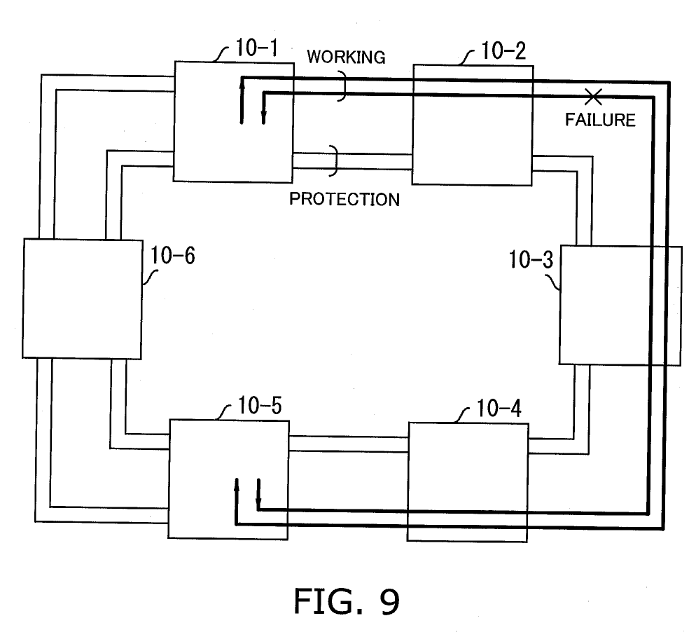

FIG. 9 shows a problem situation where a link failure has occurred in the ring network of FIG. 8. The failure disrupts the incoming optical signals to the first optical transmission unit 10-1 which is currently selecting the working facilities to receive them.

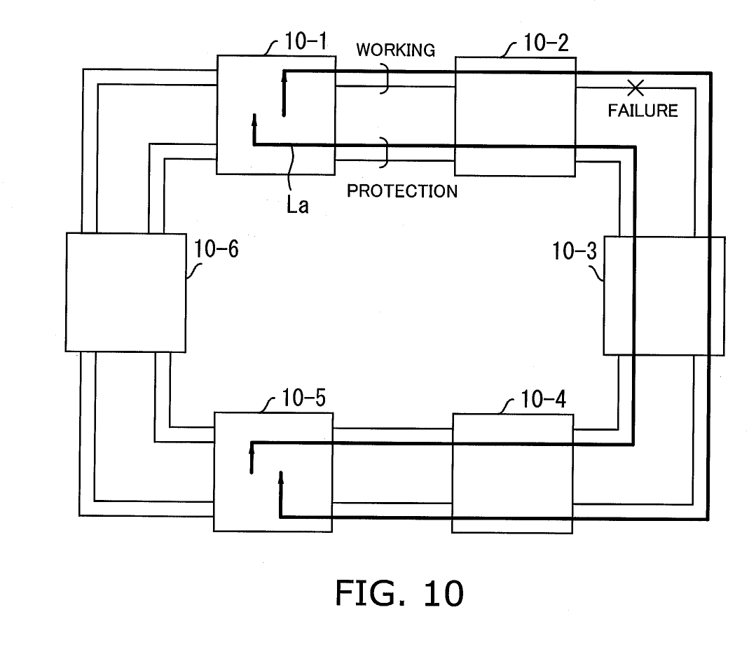

FIG. 10 shows protection switching performed to address the problem situation of FIG. 9. As a result of unidirectional protection switching, the failed incoming signal path is replaced with an alternative path La on the protection side. This switching process is accomplished in the following steps.

First, the control channel manager 1 in the first optical transmission unit 10-1 receives a failure report. Depending on the severity level of the failure, the protection switching controller 3 determines whether to initiate a protection switching process. If it turns out that protection switching is necessary, then the first optical transmission unit 10-1 examines the presence of a dummy light on the protection fiber that backs up the failed fiber. The dummy light ensures the integrity of that fiber, and thus the first optical transmission unit 10-1 determines that protection switching is possible. It then transmits a switching request command to the peer unit 10-5. The two optical transmission units 10-1 and 105 enters the protection mode, reconfiguring their respective optical switch fabrics 2 so that the communication will be restored.

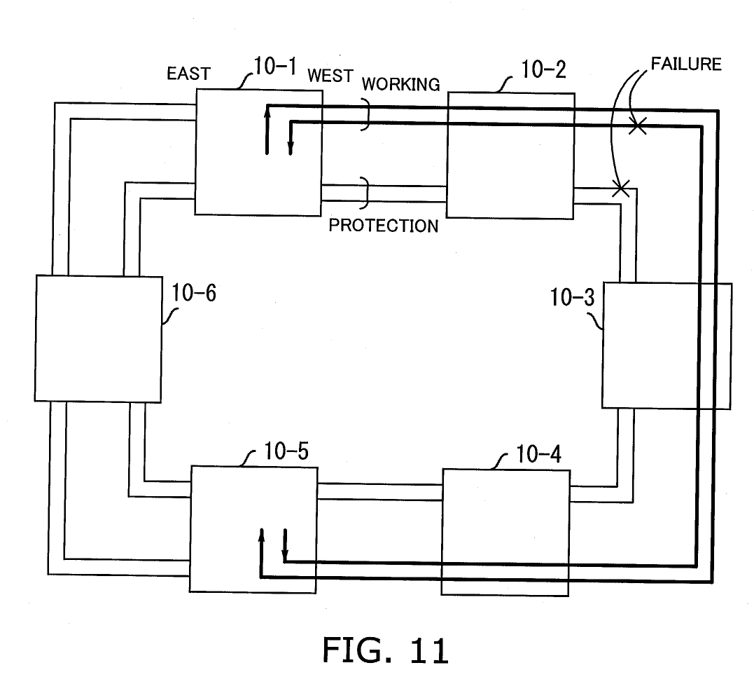

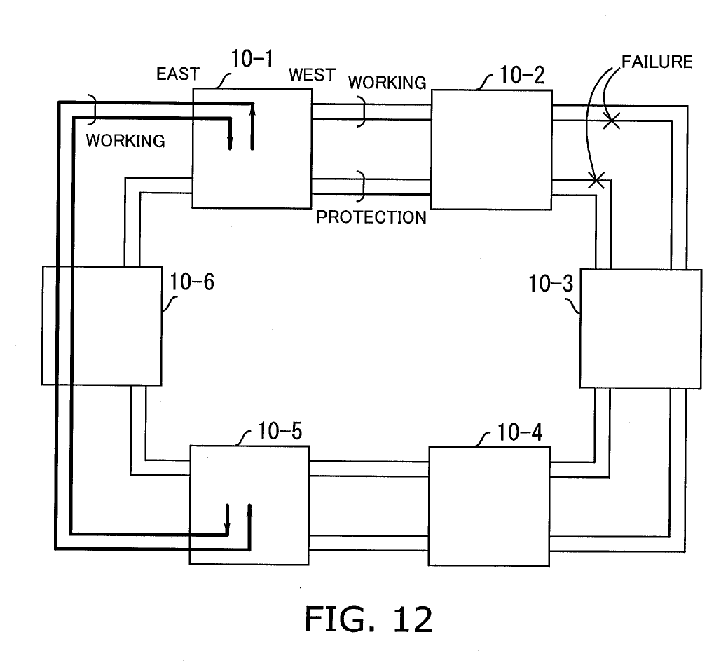

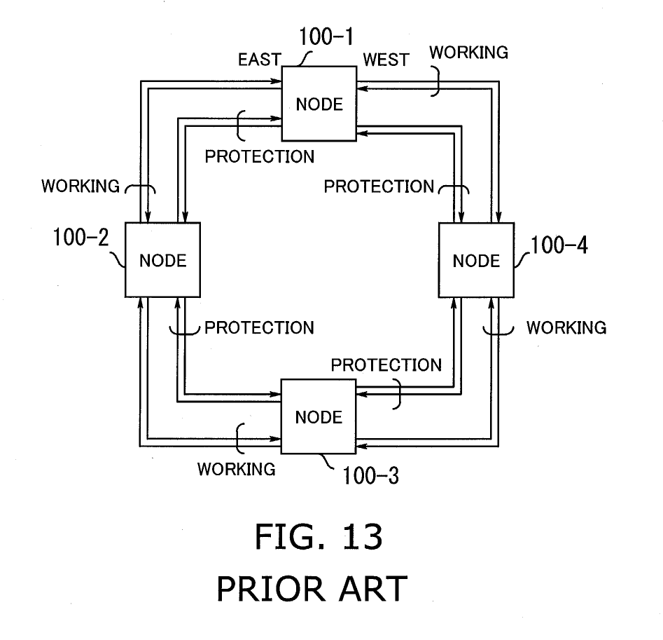

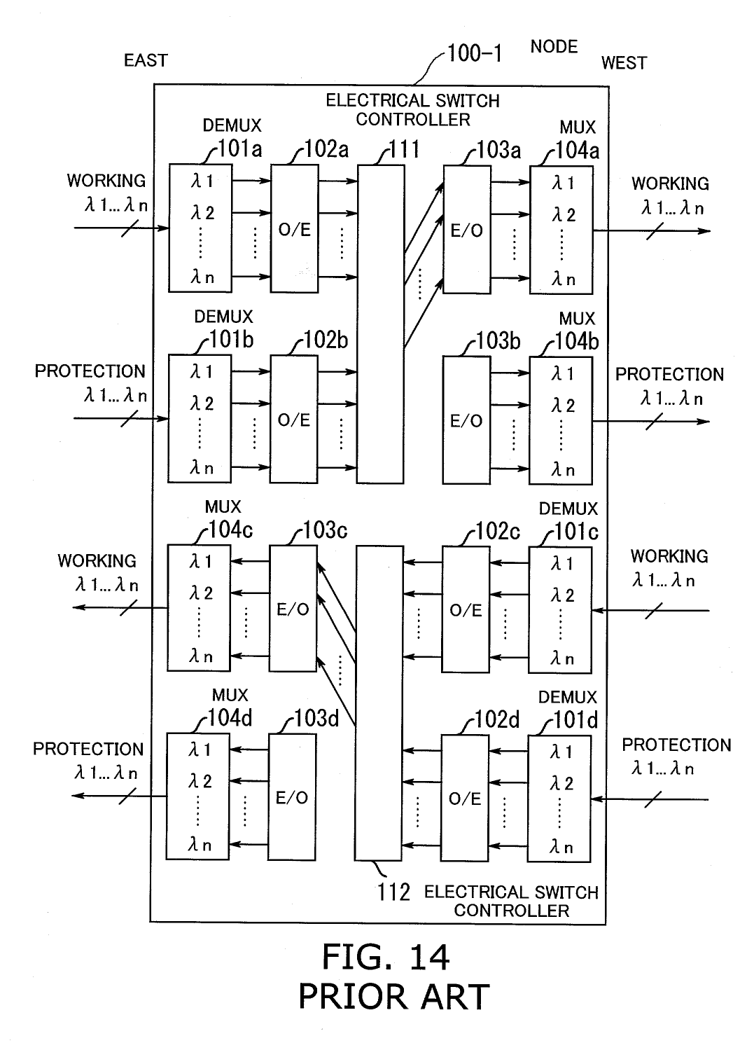

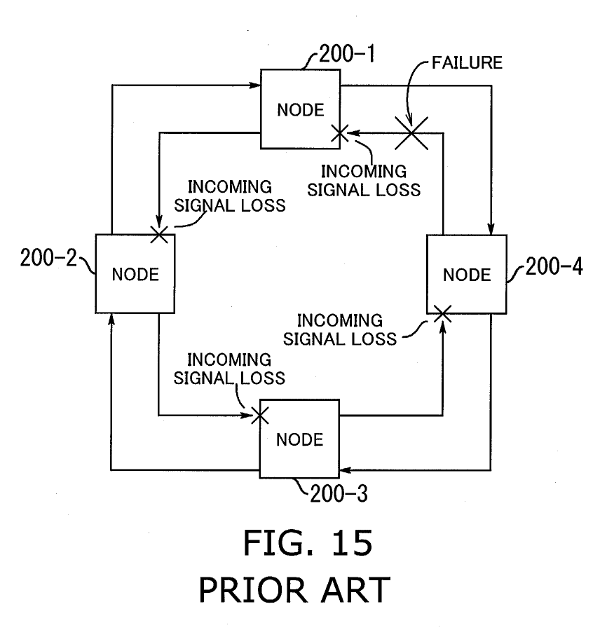

FIG. 11 shows another example of a problem situation in the same ring network, where both working and protection channels are disrupted when the first optical transmission unit 10-1 is operating with its west-side links. FIG. 12 shows a result of protection switching performed to solve the problem of FIG. 11. As seen, the optical transmission units 10-1 and 10-5 now attempt to recover the communication by using the eastbound route to transport main signals through the sixth optical transmission unit 10-6.

The process of protection switching proceeds in the same way as in the case of FIG. 10. The difference is that the first optical transmission unit 10-1 fails to ensure the integrity of protection facilities in the situation of FIG. 11. Accordingly, the first optical transmission unit 10-1 changes the signal direction from westbound to eastbound.

The switched channels are reverted (i.e., returned to their original state) when the cause of failure is removed. Suppose, for example, that a working channel went down and a protection channel took the place of the failed channel. The system continues monitoring the status of the failed working channel, and when the failure is successfully resolved, it restores the previous state, thus releasing the protection channel.

The above discussion will now be summarized as follows. According to the present invention, the proposed optical transmission unit 10 and proposed optical transmission system are configured to use a dedicated control channel in failure recovery operations. They also produce a dummy light not to make any part of the ring network what is called “dark fibers.” This configuration of the present invention facilitates the system to locate a failure and examine the integrity of protection channels, thus improving the efficiency of failure recovery processes.

The proposed system optically switches main signals, while terminating solely the control channel at each node by converting the signal into electrical form. Compared to conventional systems which use electrical switches, the proposed system can accommodate far more channels and provide greater flexibility in transmission methods, without increasing the size of equipment.

While the invention has been described under the assumption that the main signal channels and control channel are multiplexed together for transmission over a signal medium, the present invention should not limited to that configuration. The control channel signal may be transported on a separate transmission medium, or even on a separate network with a different topology. For example, the system may employ an administration server for management of the entire ring network, which includes a control channel manager 1 of the present invention. In this case, the single control channel manager 1 sends control channel signals to a plurality of network nodes, enabling efficient centralized management of control channel.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An optical transmission unit which transports optical signals with wavelength-division multiplexing techniques, comprising:
control channel management means for managing a control channel and a control channel signal thereon for use in failure recovery operations;
optical switching means for switching optical connection paths between working facilities and protection facilities to route the optical signals; and
switching control means for sending a switching command to said optical switching means, based on the control channel signal.

2. The optical transmission unit according to claim 1, wherein said control channel management means allocates a wavelength to the control channel, the wavelength being selected from among wavelength resources reserved for the optical signals.

3. The optical transmission unit according to claim 1, wherein said control channel management means allocates a wavelength to the control channel, the wavelength being selected from among wavelength resources other than those reserved for the optical signals.

4. The optical transmission unit according to claim 1, wherein said control channel management means modulates at least one of the optical signals with the control channel signal.

5. The optical transmission unit according to claim 1, wherein said control channel management means sets the control channel on a transmission medium that is provided separately from that of the optical signals.

6. The optical transmission unit according to claim 1, further comprising dummy light transmission means for transmitting a dummy light to either the protection facilities or the working facilities, whichever remain unused.

7. The optical transmission unit according to claim 1, further comprising optical wavelength converting means for converting one of the optical signals to a different optical wavelength.

8. An optical transmission system which transports optical signals over a ring network with wavelength-division multiplexing techniques, comprising:
(a) a plurality of optical transmission units, each comprising:
control channel management means for managing a control channel and a control channel signal thereon for use in failure recovery operations,
optical switching means for switching optical connection paths between working facilities and protection facilities to route the optical signals, and
switching control means for sending a switching command to said optical switching means, based on the control channel signals; and
optical transmission media to interconnect said plurality of optical transmission units in a ring topology so as to form the ring network.

9. The optical transmission system according to claim 8, wherein:
said optical switching means is further capable of switching between eastbound and westbound routes of the ring network; and
said switching control means sends the switching command when a failure is detected, requesting said optical switching means to perform switching between the working and protection facilities and/or between the eastbound and westbound routes of the ring network.
